(19) United States
(12) Patent Application Publication
(10) Pub. No.: US 2025/0294012 A1
(43) Pub. Date: Sep. 18, 2025

(54) GATEWAY DEVICE

(71) Applicant: TOYOTA JIDOSHA KABUSHIKI KAISHA, Toyota-shi (JP)

(72) Inventor: Seigo TAKAI, Toyota-shi (JP)

(73) Assignee: TOYOTA JIDOSHA KABUSHIKI KAISHA, Toyota-shi (JP)

(21) Appl. No.: 19/016,062

(22) Filed: Jan. 10, 2025

(30) Foreign Application Priority Data
Mar. 12, 2024 (JP) 2024-038039

(51) Int. Cl. H04L 9/40

(52) U.S. Cl. CPC H04L 63/029

(57) ABSTRACT

The storage device stores a correspondence map. The correspondence map indicates a correspondence relationship between a plurality of groups, an electronic control device belonging to the group, and a network constituted by the electronic control device. The execution device refers to the correspondence map and identifies a group to which the node information included in the received activation request message belongs. The execution device determines a network including an electronic control device belonging to the specified group as a relay destination, without using a network including an electronic control device belonging to the specified group as a relay bond.

### CROSS-REFERENCE TO RELATED APPLICATION

This application claims priority to Japanese Patent Application No. 2024-038039 filed on Mar. 12, 2024, incorporated herein by reference in its entirety.

### BACKGROUND

### 1. Technical Field

The present disclosure relates to a gateway device.

### 2. Description of Related Art

Japanese Unexamined Patent Application Publication No. 2017-144893 (JP 2017-144893 A) discloses an in-vehicle network system in which a plurality of electronic control devices mounted on a vehicle communicates with each other. A protocol of a controller area network (CAN) is applied to communication via a communication bus in the in-vehicle network system.

### SUMMARY

There is known a partial network in which, among the electronic control devices in the in-vehicle network system as described in JP 2017-144893 A, only part of the electronic control devices is activated and the remaining electronic control devices are kept in a sleep state. With the partial network, the power consumption of the in-vehicle network system can be reduced.

The electronic control device adapted to the partial network is activated and makes transition to an active state in response to reception of an activation request message including a specific frame assigned individually. The active state is a state in which the electronic control device can execute an application.

In response to reception of an activation request message that does not include the specific frame assigned to the electronic control device adapted to the partial network, the electronic control device ignores the activation request message. Thus, the electronic control device keeps the sleep state. The sleep state is a state in which the function of executing the application is stopped to reduce the power consumption.

An electronic control device that is not adapted to the partial network does not have a configuration for transmitting the activation request message including the specific frame assigned individually. Therefore, the electronic control device that directly receives the activation request message transmitted from the electronic control device that is not adapted to the partial network is activated even though the electronic control device need not be activated.

To solve the above problem, the present disclosure provides a gateway device to be applied to an in-vehicle network system in which a plurality of electronic control devices constitutes a network for each communication bus and performs communication conforming to a protocol of a controller area network. The gateway device is configured to relay communication between the electronic control devices with a plurality of the networks connected to the gateway device. The gateway device includes a storage device and an execution device.

The storage device is configured to store a correspondence map indicating correspondence relationships among a plurality of groups indicating combinations of some of the electronic control devices out of the plurality of electronic control devices, the electronic control devices belonging to the groups, and the networks constituted by the electronic control devices.

The execution device is configured to, when an activation request message including information indicating the electronic control device that is a transmission source is received from the electronic control device and the received activation request message does not include activation target information indicating the electronic control device to be activated, identify the group to which the electronic control device that is the transmission source in the received activation request message belongs by referring to the correspondence map, and determine, as a relay destination, the network including the electronic control device belonging to the identified group without determining, as the relay destination, the network that does not include the electronic control device belonging to the identified group.

When the electronic control device that is the transmission source is not adapted to the partial network, the gateway device can suppress activation of the electronic control device on the network that does not include the electronic control device belonging to the same group as that of the electronic control device that is the transmission source.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an in-vehicle network system;

FIG. 2 is a schematic diagram illustrating an activation request message corresponding to a partial network;

FIG. 3 is a schematic diagram illustrating an activation request message that does not correspond to a partial network;

FIG. 4 is an explanatory diagram illustrating a correspondence map;

FIG. 5 is a flow chart illustrating a series of processes performed by the gateway device upon receipt of an activation request message; and

FIG. 6 is an explanatory diagram illustrating an example of a flow of an activation request message.

### DETAILED DESCRIPTION OF EMBODIMENTS

### Embodiment

Hereinafter, an embodiment of a gateway device will be described with reference to the drawings. In the following description, a vehicle including an in-vehicle network system will be described.

### In-Vehicle Network System

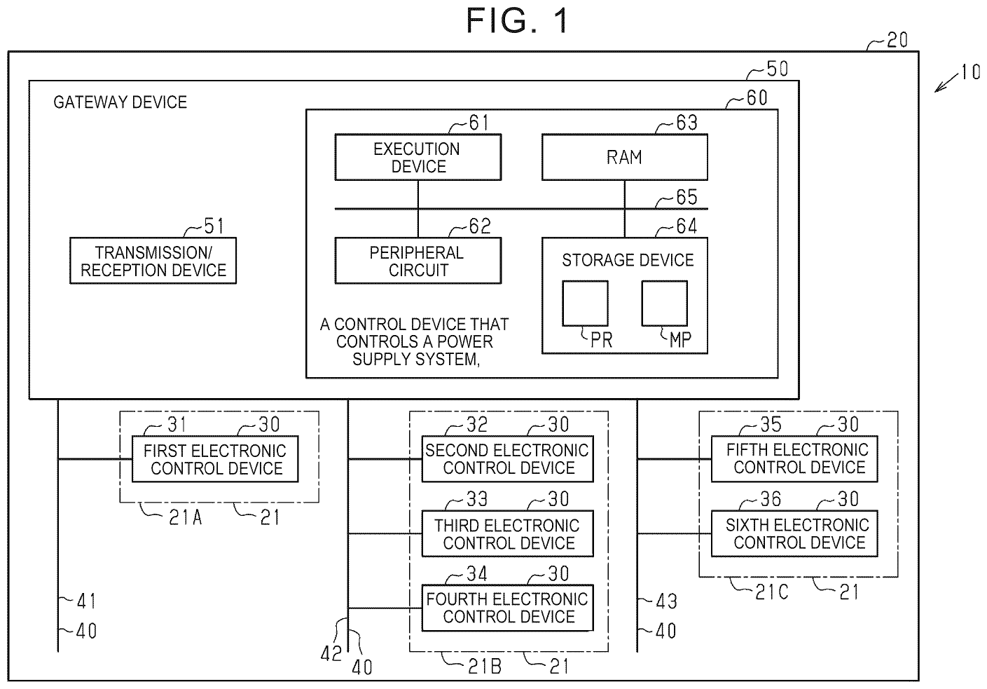

As illustrated in FIG. 1, the vehicle 10 includes an in-vehicle network system 20. The in-vehicle network system 20 includes a plurality of electronic control devices 30, a plurality of communication buses 40, and a gateway device 50. The communication bus 40 is connected to the gateway device 50. Each electronic control device 30 is connected to the gateway device 50 via a plurality of communication buses 40. In the in-vehicle network system 20, a plurality of electronic control devices 30 constitute a network 21 for each communication bus 40.

In the present embodiment, the in-vehicle network system 20 includes six electronic control devices 30 and three communication buses 40. The six electronic control devices 30 constitute three networks 21 for each communication bus 40.

Specifically, the first electronic control device 31 is connected to the gateway device 50 via the first communication bus 41. In the first communication bus 41, the first network 21A is constituted by the first electronic control device 31. The first electronic control device 31 does not support a partial network.

The second electronic control device 32, the third electronic control device 33, and the fourth electronic control device 34 are connected to the gateway device 50 via the second communication bus 42. In the second communication bus 42, the second network 21B is constituted by a second electronic control device 32, a third electronic control device 33, and a fourth electronic control device 34. The second electronic control device 32 and the third electronic control device 33 do not support a partial network. The fourth electronic control device 34 corresponds to a partial network.

The fifth electronic control device 35 and the sixth electronic control device 36 are connected to the gateway device 50 via the third communication bus 43. In the third communication bus 43, the third network 21C is constituted by a fifth electronic control device 35 and a sixth electronic control device 36. The fifth electronic control device 35 and the sixth electronic control device 36 do not support a partial network.

The electronic control device 30 stores an application (not shown). The electronic control device 30 is capable of transitioning its state to an active state or a sleep state. The active state is a state in which the electronic control device 30 can execute an application. The sleep state is a state in which the function of executing the application is stopped to reduce power consumption as compared with the case of the active state.

The plurality of electronic control devices 30 communicate with each other via the gateway device 50 in compliance with CAN protocol. When another electronic control device 30 needs to be activated, the electronic control device 30 transmits an activation-request-message MS to the gateway device 50 via the connected communication bus 40.

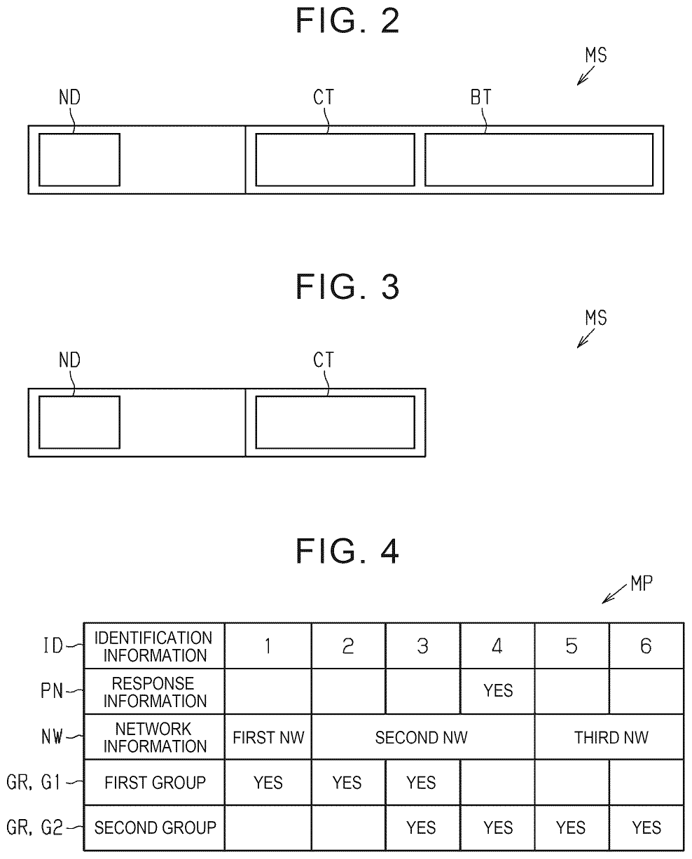

As illustrated in FIG. 2, the electronic control device 30 corresponding to the partial network transmits a message including the node information ND, the control information CT, and the activation target information BT as the activation-request message MS. The node information ND is information indicating the electronic control device 30 of the transmitting source. The control information CT is information indicating that activation is requested. The activation target information BT is a particular frame in which information indicating the activation target electronic control device 30 is individually assigned. More specifically, a node-information ND is included in a header of the message. In addition, the control information CT and the activation target information BT are included in the payload of the message.

As illustrated in FIG. 3, the electronic control device 30 that does not support the partial network transmits a message including the node information ND and the control information CT and not including the activation target information BT as the activation-request message MS.

When receiving the activation request message MS in the sleep state, the electronic control device 30 corresponding to the partial network activates and transitions to the active state when the activation request message MS includes a particular frame individually assigned thereto.

When receiving the activation request message MS in the sleep mode, the electronic control device 30 corresponding to the partial network ignores the received activation request message MS if a particular frame individually assigned to the activation request message MS is not included. As a result, the electronic control device 30 maintains the sleep state.

When the electronic control device 30 that does not support the partial network receives the activation-request-message MS in the sleep state, the electronic control device starts up and shifts to the active state regardless of the presence or absence of a particular frame assigned individually.

### Gateway Device

As illustrated in FIG. 1, the gateway device 50 is applied to an in-vehicle network system 20. The gateway device 50 is connected to a plurality of networks 21 and relays communication between the plurality of electronic control devices 30. The gateway device 50 relays communication between the electronic control devices 30. The gateway device 50 includes a transmission/reception device 51 and a control device 60.

The transmission/reception device 51 receives a message transmitted from the electronic control device 30 via the communication bus 40. Further, the transmission/reception device 51 transmits a message to the electronic control device 30 via the communication bus 40. That is, the transmission/reception device 51 has a relay function.

The control device 60 controls the transmission/reception device 51. The control device 60 includes an execution device 61, peripheral circuits 62, a RAM 63, a storage device 64, and an internal bus 65. The internal bus 65 communicatively connects the execution device 61, the peripheral circuit 62, RAM 63, and the storage device 64 to each other. The peripheral circuit 62 includes a circuit that generates a clock signal that defines an internal operation, a power supply circuit, a reset circuit, and the like. RAM 63 stores data generated in association with the operation of the execution device 61. The storage device 64 stores relay program PR to be executed by the execution device 61 and correspondence map MP to be referred to in association with the execution of the relay program PR.

As illustrated in FIG. 4, the correspondence map MP is a map indicating a correspondence relation between a plurality of group GR, the electronic control device 30 belonging to the group GR, and the network 21 constituted by the electronic control device 30.

Specifically, the correspondence map MP includes identification-information ID indicating a plurality of electronic control devices 30. In the present embodiment, for the identification-information ID, the first electronic control device 31 to the sixth electronic control device 36 correspond to the numbers “1” to “6”.

The correspondence map MP includes correspondence information PN indicating whether or not the identification information ID corresponds to a partial network. In FIG. 4, the column of the identification information ID indicating the electronic control device 30 corresponding to the partial network is shown as “YES” as the correspondence information PN. Therefore, “YES” is indicated in the column “4” indicating the number of the identification-information ID indicating the fourth electronic control device 34 among the six electronic control devices 30.

The correspondence map MP includes network information NW indicating the configured network 21 for each identification information ID. In FIG. 4, as the network information NW, the identification information ID indicating the first electronic control device 31 is indicated in the column “1” as “first NW” indicating the first network 21A. As the network information NW, a column of “2” for the identification information ID, a column of “3” for the identification information ID, and a column of “4” for the identification information ID indicate “second NW” indicating the second network 21B. The column of “5” for the identification information ID and the column of “6” for the identification information ID indicate “third NW” indicating the third network 21C.

The correspondence map MP includes a plurality of pieces of group GR. The group GR is a combination of some electronic control devices 30 among the plurality of electronic control devices 30 included in the in-vehicle network system 20. Specifically, the correspondence map MP includes information indicating the first group G1 and information indicating the electronic control device 30 belonging to the first group G1. The first group G1 is a group GR indicating the combination of electronic control devices 30 that need to be activated to implement a particular first function of the vehicle 10. That is, the in-vehicle network system 20 realizes the first function of the vehicles 10 by combining the applications of the electronic control devices 30 belonging to the first group G1. In the embodiment shown in FIG. 4, the electronic control device 30 belonging to the first group G1 is the first electronic control device 31, the second electronic control device 32, and the third electronic control device 33. Therefore, “YES” is shown in a column where the identification information ID corresponding to the first group G1 is “1”, a column where the identification information ID is “2”, and a column where the identification information ID is “3”.

The correspondence map MP includes information indicating the second group G2 and information indicating the electronic control device 30 belonging to the second group G2. The second group G2 is a group GR indicating a combination of the electronic control devices 30 that need to be activated in order to realize a second function that differs from the first function of the vehicles 10. That is, the in-vehicle network system 20 realizes the second function of the vehicles 10 by combining the applications of the electronic control devices 30 belonging to the second group G2. In the embodiment shown in FIG. 4, the electronic control devices 30 belonging to the second group G2 are a third electronic control device 33, a fourth electronic control device 34, a fifth electronic control device 35, and a sixth electronic control device 36. Therefore, “YES” is shown in a column where the identification information ID corresponding to the second group G2 is “3”, a column where the identification information ID is “4”, a column where the identification information ID is “5”, and a column where the identification information ID is “6”.

Series of processing in relay control

When the transmission/reception device 51 receives the activation-request-message MS from the electronic control device 30, the execution device 61 starts execution of the relay program PR.

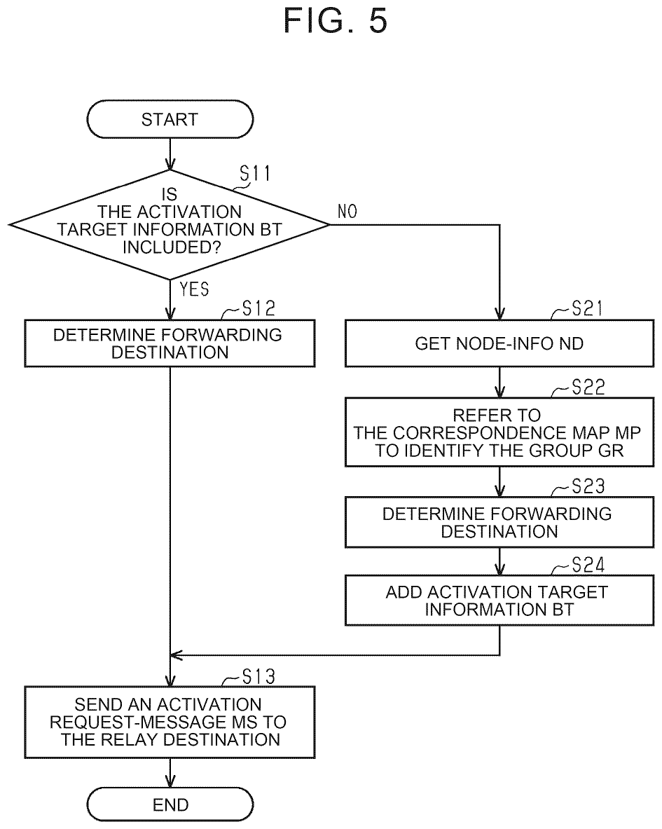

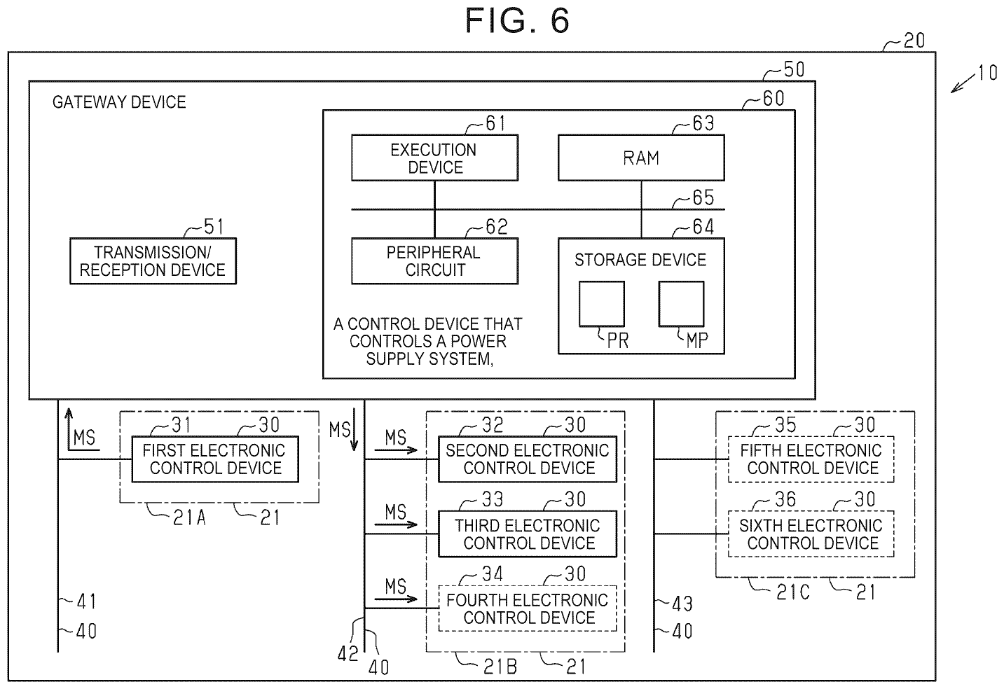

As illustrated in FIG. 5, when the execution device 61 starts execution of the relay program PR, the execution device 61 first performs a S11 process. In S11, the execution device 61 determines whether or not the received activation request message MS includes the activation target information BT. When the execution device 61 determines that the activation target information BT is included (S11: YES), the execution device 61 advances the process to S12.

In S12, the execution device 61 determines the relay destination based on the activation target information BT included in the activation request message MS. Specifically, the execution device 61 specifies the electronic control device 30 indicated by the activation target information BT included in the activation request-message MS. Next, the execution device 61 identifies the network 21 in which the identified electronic control device 30 is included. Then, the execution device 61 determines the network 21 including the specified electronic control device 30 as the relay destination without using the network 21 not including the specified electronic control device 30 as the relay destination. Thereafter, the execution device 61 advances the process to S13.

In S13, the execution device 61 controls the transmission/reception device 51 to transmit the activation-request-message MS only to the determined relay destination. Thereafter, the execution device 61 ends the current series of processes.

On the other hand, when the execution device 61 determines that the received activation request message MS does not include the activation target information BT (S11: NO), the execution device 61 advances the process to S21. In S21, the execution device 61 acquires the node-information ND included in the received activation-request-message MS. Thereafter, the execution device 61 advances the process to S22.

In S22, the execution device 61 refers to the correspondence map MP and identifies the group GR to which the electronic control device 30 indicated by the acquired node-information ND belongs. Thereafter, the execution device 61 advances the process to S23.

In S23, the execution device 61 determines the relay destination based on the group GR specified in S22. Specifically, the execution device 61 refers to the correspondence map MP and identifies the electronic control device 30 belonging to the identified group GR. Next, the execution device 61 refers to the correspondence map MP and identifies the network 21 including the identified electronic control device 30. Then, the execution device 61 determines the network 21 including the electronic control device 30 belonging to the specified group GR as the relay destination without using the network 21 not including the electronic control device 30 belonging to the specified group GR as the relay destination. Thereafter, the execution device 61 advances the process to S24.

In S24, the execution device 61 adds the activation target information BT to the received activation request message MS. Specifically, the execution device 61 adds, as the activation target information BT, information indicating the electronic control device 30 belonging to the group GR specified in S22 to the payload of the received activation-request-message MS. The information indicating the electronic control device 30 belonging to the specified group GR is a specific frame individually assigned to each electronic control device 30 belonging to the group GR. Thereafter, the execution device 61 advances the process to S13. In the present embodiment, when proceeding to S13 via S24, the execution device 61 transmits the activation-request-message MS to which the activation target-information BT is added to the relay destination. Thereafter, the execution device 61 ends the current series of processes.

### Operations of Embodiment

As illustrated in FIG. 6, in the above-described embodiment, it is assumed that the first electronic control device 31 transmits an activation-request-message MS to the gateway device 50. The first electronic control device 31 does not support a partial network. Therefore, the transmission/reception device 51 receives the activation-request-message MS that does not include the activation-target-information BT.

In this situation, the execution device 61 makes a negative determination in S11 process illustrated in FIG. 5. Next, the execution device 61 acquires the number “1” of the identification information ID as the node information ND to be acquired in S21.

Next, in S22, the execution device 61 refers to the correspondence map MP illustrated in FIG. 4 and identifies the group GR to which the first electronic control device 31 having the identification-information ID of “1” belongs as the first group G1.

Next, in S23, the execution device 61 refers to the correspondence map MP and identifies that the first electronic control device 31, the second electronic control device 32, and the third electronic control device 33 belonging to the first group G1 are to be activated.

Next, the execution device 61 determines the first network 21A including the first electronic control device 31 and the second network 21B including the second electronic control device 32 and the third electronic control device 33 as the relay destination. On the other hand, the execution device 61 does not use the third network 21C that does not include the first electronic control device 31, the second electronic control device 32, and the third electronic control device 33 as the relay destination.

Next, in S24, the execution device 61 adds the particular frame assigned to the first electronic control device 31, the second electronic control device 32, and the third electronic control device 33 to the activation request-message MS as activation target-information BT.

Then, in S13, the execution device 61 transmits an activation-request-message MS in which the activation target-information BT is added to the first network 21A and the second network 21B that are the relay destinations.

Thus, as shown in FIG. 6, the second electronic control device 32, the third electronic control device 33, and the fourth electronic control device 34 included in the second network 21B receive the activation-request-message MS. The second electronic control device 32 and the third electronic control device 33 are activated by receiving the activation-request-message MS. The fourth electronic control device 34 corresponds to a partial network. Therefore, since the activation request message MS does not include a particular frame assigned to the fourth electronic control device 34, the fourth electronic control device 34 receives the activation request message MS, but refers to the activation target information BT and maintains the sleep status. In FIG. 6, the electronic control device 30 that maintains the sleep state is indicated by a broken line.

In addition, the execution device 61 does not transmit the activation-request-message MS to the third network 21C that is not the relay destination. Accordingly, the fifth electronic control device 35 and the sixth electronic control device 36 included in the third network 21C do not receive the activation request-message MS. Therefore, the fifth electronic control device 35 and the sixth electronic control device 36 maintain the sleep state.

In this way, in the in-vehicle network system 20, the first electronic control device 31, the second electronic control device 32, and the third electronic control device 33 necessary for realizing the first function of the vehicle 10 are shifted to the active state. On the other hand, the fourth electronic control device 34, the fifth electronic control device 35, and the sixth electronic control device 36, which are unnecessary for realizing the first function of the vehicle 10, maintain the sleep state.

### Effects of Embodiment

(1) In the above-described embodiment, when the activation target information BT is not included in the activation request message MS received by the gateway device 50, the electronic control device 30 of the transmitting source does not support the partial network. According to the above-described embodiment, the execution device 61 refers to the correspondence map MP by S22 to identify the group GR to which the electronic control device 30 of the transmitting source belongs. Then, the execution device 61 does not use the network 21 that does not include the electronic control device 30 belonging to the specified group GR as the relay destination by S23. The execution device 61 determines that the network 21 including the electronic control device 30 belonging to the identified GR is the relay destination. Therefore, the gateway device 50 can prevent the electronic control device 30 of the network 21 that does not include the electronic control device 30 belonging to the same group GR as the electronic control device 30 of the transmitting source from being activated.

(2) According to the above-described embodiment, the gateway device 50 adds information indicating the electronic control device 30 belonging to the specified group GR as the activation target information BT to the activation request message MS transmitted to the relay destination by S24. Therefore, when the gateway device 50 transmits the activation request message MS to the relay destination network 21, there may be an electronic control device 30 corresponding to the partial network in the network 21. In this case, even when the activation request message MS received from the electronic control device 30 that does not support the partial network is relayed, the activation request message MS can be relayed corresponding to the partial network. In some cases, an electronic control device 30 corresponding to a partial network exists in the relay destination network 21 and does not belong to the group GR specified by the electronic control device 30. At this time, the gateway device 50 can prevent the electronic control device 30 from being activated.

(3) In the above-described embodiment, the activation target information BT is included in the activation request message MS received by the gateway device 50, and the electronic control device 30 of the transmitting source corresponds to the partial network. The execution device 61 does not use the network 21 that does not include the electronic control device 30 indicated by the activation target information BT included in the received activation request message MS as a relay destination. On the other hand, the execution device 61 determines the network 21 including the electronic control device 30 indicated by the activation target information BT as the relay destination. Therefore, if the activation request message MS is transmitted to all the networks 21, the electronic control device 30 that does not support the partial network receives the activation request message MS and transitions to the active-state. According to the above-described embodiment, even if the electronic control device 30 that does not support the partial network exists in the network 21 that is not the relay destination, it is possible to prevent the electronic control device 30 from shifting to the active state.

(4) According to the above-described embodiment, the execution device 61 determines whether or not the received activation request message MS includes the activation target information BT. As a result, the execution device 61 can proceed with a process in a case where the activation target information BT is not included or a process in a case where the activation target information BT is included, according to the determination result.

### Other Embodiments

The present embodiment can be realized with the following modifications. The present embodiment and the following modifications can be combined with each other within a technically consistent range to be realized.

The execution device 61 does not have to determine whether or not the received activation request message MS includes the activation target information BT. For example, the execution device 61 may acquire the determination result by determining whether or not the activation target information BT is included in the activation request message MS received by the transmission/reception device 51 and outputting the determination result to the execution device 61.

When the activation target information BT is included in the received activation-request-message MS, the execution device 61 may determine all the networks 21 as the relay destinations. For example, when the proportion of the electronic control device 30 corresponding to the partial network is high among the plurality of electronic control devices 30, the proportion of the electronic control device 30 capable of maintaining the sleep state can be secured even when all the networks 21 are used as the relay destinations.

The execution device 61 may relay the activation request message MS to be transmitted to the relay destination without adding information indicating the electronic control device 30 belonging to the identified GR as the activation target information BT. Even in this case, by not transmitting the activation-request-message MS to the network 21 which is not the relay destination, it is possible to prevent the electronic control device 30 included in the network 21 which is not the relay destination from shifting to the active-state.

The execution device 61 may add the activation target information BT to only the network 21 including the electronic control device 30 corresponding to the partial network among the networks 21 of the relay destinations. That is, the activation request-message MS may be transmitted to the network 21 that does not include the electronic control device 30 corresponding to the partial network among the relay destination networks 21 without adding the activation target-information BT.

In the above-described embodiment, the plurality of group GR are set for each function of the vehicles 10 to be realized, but the present disclosure is not limited thereto. For example, the plurality of group GR may be set for each control target controlled by the electronic control devices 30.

The control device 60 may be configured as a circuitry including one or more processors that execute various processes in accordance with a computer program (software). The control device 60 may be configured as a circuit that includes one or more dedicated hardware circuits, such as an application-specific integrated circuit (ASIC), or a combination thereof, that perform at least some of the various processes. The processor includes a CPU and a memory such as a random access memory (RAM) and a ROM. The memory stores a program code or an instruction configured to execute the CPU to perform processes. The memory, that is, the computer-readable medium includes any available media that can be accessed by a general purpose or special purpose computer.

What is claimed is:

1. A gateway device to be applied to an in-vehicle network system in which a plurality of electronic control devices constitutes a network for each communication bus and performs communication conforming to a protocol of a controller area network, the gateway device being configured to relay communication between the electronic control devices with a plurality of the networks connected to the gateway device, the gateway device comprising a storage device and an execution device, wherein:
the storage device is configured to store a correspondence map indicating correspondence relationships among a plurality of groups indicating combinations of some of the electronic control devices out of the plurality of electronic control devices, the electronic control devices belonging to the groups, and the networks constituted by the electronic control devices; and
the execution device is configured to, when an activation request message including information indicating the electronic control device that is a transmission source is received from the electronic control device and the received activation request message does not include activation target information indicating the electronic control device to be activated,
identify the group to which the electronic control device that is the transmission source in the received activation request message belongs by referring to the correspondence map, and
determine, as a relay destination, the network including the electronic control device belonging to the identified group without determining, as the relay destination, the network that does not include the electronic control device belonging to the identified group.

2. The gateway device according to claim 1, wherein the execution device is further configured to add information indicating the electronic control device belonging to the identified group as the activation target information to the activation request message to be transmitted to the relay destination.

3. The gateway device according to claim 1, wherein the execution device is further configured to, when the activation request message is received from the electronic control device and the received activation request message includes the activation target information, determine, as the relay destination, the network including the electronic control device indicated by the activation target information in the received activation request message without determining, as the relay destination, the network that does not include the electronic control device indicated by the activation target information in the received activation request message.

4. The gateway device according to claim 1, wherein the execution device is further configured to, when the activation request message is received from the electronic control device, determine whether the received activation request message includes the activation target information.
